(19) United States
(12) Patent Application Publication
(10) Pub. No.: US 2015/0045116 A1
(43) Pub. Date: Feb. 12, 2015

(54) Loyalty Rewards Points With Interest Accrual Wagering System

(71) Applicant: Techlink International Entertainment Limited, Sydney (CA)

(72) Inventor: John Xidos, Sydney (CA)

(73) Assignee: TECHLINK INTERNATIONAL ENTERTAINMENT LIMITED, Sydney (CA)

(21) Appl. No.: 14/522,122

(22) Filed: Oct. 23, 2014

Related U.S. Application Data
(63) Continuation-in-part of application No. 14/394,950.
(60) Provisional application No. 61/635,069, filed on Apr. 18, 2012.

(51) Int. Cl. G07F 17/32

(52) U.S. Cl. CPC G07F 17/3255
USPC 463/25

(57) ABSTRACT

The invention relates to systems and methods of gaming on Internet connected devices, such as computers and mobile devices. In particular, the invention relates to a novel method of playing games—such as slots, keno, poker and variations of games of chance or skill—where the player is able to wager loyalty points from one or more loyalty point providers. The resulting wins or losses in the games will be added or subtracted as loyalty rewards points or as points multipliers on future purchases to the player's account. The system and method are particularly suited for deployment on Internet websites and Internet applications (accessible by Internet connected devices such as desktop computers, laptops, tablets, mobile devices), computer gaming systems, gaming consoles, or Internet connected gaming terminals (a video lottery terminal slot machine).

### CROSS-REFERENCE TO RELATED APPLICATIONS

The present application is a continuation-in-part of U.S. application Ser. No. 14/394,950 which is a national phase entry of International Application Serial No. PCT/CA2013/000376, filed on Apr. 17, 2013 which claims the benefit of priority to U.S. Provisional Application Ser. No. 61/635,069. Each of these applications is incorporated herein by reference in entirety.

### FIELD OF THE INVENTION

The invention relates to systems and methods of gaming on Internet connected devices, such as computers and mobile devices. In particular, the invention relates to a novel method of playing games—such as slots, keno, poker and variations of games of chance or skill—where the player is able to wager loyalty points from one or more loyalty point providers. The resulting wins or losses in the games will be added or subtracted as loyalty rewards points or as points multipliers on future purchases to the player's account. In addition, the system encourages user participation by crediting a user's account with additional loyalty points paid as interest when a user maintains a loyalty points balance within the player's account. The system and method are particularly suited for deployment on Internet websites and Internet applications (accessible by Internet connected devices such as desktop computers, laptops, tablets, mobile devices), computer gaming systems, gaming consoles, or Internet connected gaming terminals (a video lottery terminal slot machine).

### BACKGROUND OF THE INVENTION

Global gambling revenues from the Internet gaming and gambling industry is currently a $420 billion a year industry (GBGC-Global Gambling Report, 2012) that is forecast to continue to grow for the foreseeable future. Currently, millions of players access on-line gaming and gambling sites on an annual basis to play games of chance. These players during the course of play may wager money or simply play games for “entertainment” or non-monetary points. The number of users/players is continuing to increase each year.

At one level, the Internet gaming industry is presently in a state of uncertainty due to many jurisdictional laws that are intended to prevent unauthorized gaming websites from being operated and/or to prevent the operation of gaming websites that cannot be directly monitored and/or controlled by government regulators. Governments desire to maintain control for two main reasons, namely to monitor profits associated with gaming for taxation purposes and to ensure that gaming is being conducted in accordance with acceptable social standards such as preventing underage play and/or to minimize problem gambling.

Importantly, unauthorized gaming is generally considered to have occurred when money is won or lost during a gaming session. Alternatively, when a player undertakes interaction with a gaming site, where money is not won or lost, the gaming site is generally considered to simply be providing entertainment to the player.

In addition to the growth of the Internet gaming industry, loyalty programs through loyalty point providers (LPPs) are also continuing to grow. Based on 2010 figures, the popularity and use of loyalty programs has seen growth rates in different industries (e.g. travel, consumer products, financial services, etc.) over the past five years up to as high as 100% growth. Presently, the total loyalty points industry can be valued at approximately $50 billion per year. In other words, LPPs award their customers loyalty points (LPs) worth approximately $50 billion each year.

However, within the LP industry, approximately $16 billion worth of points go unused each year. That is, while 46% of people who are collecting LPs are actively using them, 54% of people who are enrolled with LPPs are inactive and do not use their points. In consumer terms, the average US household earns approximately $622 in points value each year but leaves $205 in points value unused each year.

The downside for LPPs is that unused LPs represent a large liability to the LPP that will continue to accrue on the books of the LPP and that may or may not represent a true liability to the LPP. That is, on paper while an LPP may have a large number of obligations to holders of the LPs, the actual liability may be substantially lower to the extent that a substantial percentage of outstanding LPs are not redeemed or are redeemed for lower value products that dilute the value of the LPs. Thus, the presence of the total potential liability on the LPP's books may be an artificial presentation of the true value of the LP liability and true value of the LPP. As a result, from the LPP's perspective, there is a need for LPs to be “consumed” or “spent” by the consumer so as to minimize, reduce or otherwise provide a more accurate picture of the true liability to the LPP in regards to outstanding LPs. In other words, there has been a need to create a more fluid market in the consumption of LPs and that encourages LP owners to access and/or utilize their LPs to a greater extent.

Examples of how LPPs have encouraged LP consumption in the past is by increasing the product and/or service offerings associated with their LPs. For example, a travel oriented LPP such as Aeroplan™ offers a wide of range of goods and non-travel related services as a way of redeeming Aeroplan™ LPs. It should be noted also that in addition to promoting the consumption of LPs and thus clearing the LP liability from the LPP books, the offering of a variety of goods and services may also improve the profitability of the LPP in that the various goods and services may be offered at a different value rate of the LP than the LP value rate that may be associated with a core travel service.

While the foregoing may assist in improving the fluidity of the market, there remains a need to still further enhance the consumption of LPs.

As is known, as discussed above, the Internet gaming industry is a huge and growing market and government regulators continue to have concerns with its control and problems that may be a result of its growth.

For example, Internet gaming may be more susceptible to underage gaming as the ability to control or confirm the age and/or identity of players is more difficult with Internet gaming due to the vast geographical distribution of participants. That is, persons under the age of majority may be able to circumvent age and/or security checks that may be in place with a gaming site through various means including false accounts or older persons assisting the younger player in getting access to the system such that there is no really effective way of preventing underage access to a gaming site.

Moreover, as is also known, money-based gaming has many potential and real personal and/or social costs/risks associated with this type of gaming. Internet gaming players are not subjected to the same type of observational or warning controls that a bricks and mortar casino or gaming establishment may have in place if or when a player exhibits behaviors that may indicate gaming problems. A bricks and mortar gaming establishment may be able to more effectively intervene or at least warn a player of the potential risks that can occur with gaming activities including damaging behavior and/or financial risk.

The issue of financial loss is significant with any form of gaming with the downside of any form of money-based gaming to be large financial losses that can have both direct and indirect personal and social costs.

In summary, there has been a need for a system that overcomes or addresses many of the problems as discussed above. In particular, there has been a need for a system that encourages LP owners to effect consumption of their points while providing entertainment and/or value to the LP owner. In addition, there has been a need for a system that overcomes problems with Internet gaming including the problems associated with players gaming with money and the attendant personal and social costs that may result from money-based gaming. Further still, there has been a need for a system that encourages the use or consumption of LPs in order to increase the fluidity of the LP market.

### SUMMARY OF THE INVENTION

In accordance with the invention, there are provided systems and methods for addressing the problems as discussed above.

According to one aspect of the invention, there is provided a system enabling one or more users to utilize loyalty points (LPs) of a loyalty points program (LPP) for credits within a gaming system and wherein each user has an LPP account with the LPP, the system comprising: a points wagering system (PWS) operatively connected to a loyalty points program (LPP) server, the PWS having an interface and software enabling users to access the LPs within their LPP account and to transfer LPs to the gaming system into a gaming system account, wherein, based on a balance of LPs within the gaming system account, interest is credited to the user's gaming system account based on pre-determined interest rules.

In certain embodiments, the pre-determined interest rules include calculating and crediting interest based on a user's activity with the PWS within time-thresholds.

In certain embodiments, a higher rate of interest is credited to the user's gaming system account if the user has PWS activity within a first time threshold and a lower rate of interest is credited to the user's account if the user has no PWS activity within a second time threshold, wherein the first time threshold is shorter than the second time threshold.

In certain embodiments, the PWS server displays information to the user regarding a current interest rate to the user based on the user's current PWS activity.

According to another aspect of the invention, there is provided a method of earning interest on loyalty points (LPs) within an account comprising the steps of: at a loyalty point provider (LPP); displaying information to a user offering the use of LPs as gaming credits within a gaming system and the opportunity to win additional LPs and earn interest on the LPs; at a points wagering system (PWS); providing LP gaming on a gaming server (GS) and crediting a user's gaming system account with additional LPs based on pre-determined interest rules.

In certain embodiments, the pre-determined interest rules include calculating and crediting interest based on the user's activity with the PWS within time-thresholds.

In certain embodiments, the method further comprises the step of crediting higher interest to the user's gaming system account if the user has PWS activity within a first time threshold and lower interest to the user's account if a user has no PWS activity within a second time threshold and where the first time threshold is shorter than the second time threshold.

In certain embodiments, the method further comprises the step of displaying information to the user regarding a current interest rate applicable to the user based on the user's current PWS activity.

### BRIEF DESCRIPTION OF THE DRAWINGS

The invention is described with reference to the accompanying figures in which:

FIG. 1 is a schematic overview of the operation of a points wagering system in accordance with various embodiments of the system;

FIG. 2 is a schematic overview of a points wagering system illustrating representative financial relationships between the parties;

FIG. 3 is a flow chart describing the operation of a points wagering system in accordance with one embodiment;

FIG. 4 is a flow chart describing the operation of a points wagering system in accordance with one embodiment;

FIG. 5 is a flow chart describing the operation of a points wagering system in accordance with one embodiment;

FIG. 6 is a representative overview of software modules in accordance with one embodiment of the invention; and,

FIGS. 7-14 are representative front-end web-page interfaces with the points wagering system including a points wagering system login screen (FIG. 7), account set-up screen (FIG. 8), loyalty program selection screen (FIG. 9), loyalty points login screen (FIG. 10), loyalty points transfer screen (FIG. 11), game selection screen (FIG. 12), game screen (FIG. 13), and loyalty points transfer screen (FIG. 14).

### DETAILED DESCRIPTION OF THE INVENTION

With reference to the figures, systems and methods are provided to enable use of loyalty points in a number of non-traditional transactions. More specifically, systems and methods are provided that encourage loyalty points (LPs) owners to effect consumption of their LPs while providing entertainment and/or value to the LP owner, that overcome problems with Internet gaming including problems associated with players gaming with money and the attendant personal and social costs that may result from money-based gaming and, systems and methods that encourage the use or consumption of LPs in order to increase the fluidity of the LP market. In various embodiments, systems and methods are provided that allow users to game with (LPs) wherein the system allows a user to accumulate additional LPs in the event that game play results in winning games thus allowing additional LPs to be credited to a user's account. Alternatively, in the event that a user wagers LPs and game play results in losing games, the user has not suffered a monetary loss per se. In addition, systems and methods are provided that credit a user's account with LP interest in order to further encourage use of a gaming system with LPs.

### System Overview

The system generally includes computer hardware and software allowing users to interface with computer systems, particularly networked computer systems utilizing the Internet to effect wagering and/or game play utilizing LPs as opposed to money. The system is described generally as a website-enabled interface allowing users to access system functionality through a personal computer. However, it is understood that the system may be deployed utilizing other computing devices including smart phones and tablet computers that may involve non-traditional website programming and that may include the use of app based graphical processing units (GPUs) as understood by those skilled in the art.

In the context of the invention, loyalty points (LPs) are points or credits that a customer/player/user (referred to as “user” hereafter) may have obtained or accumulated from financial transactions with various businesses. LPs may include points that are accumulated as part of membership with a loyalty points program (LPP), such as Air Miles™ or Aeroplan™ where a user may accumulate LPs based on purchases from different businesses associated with the LPP or a business-specific loyalty points program such as Optimum Plus™ where a user may accumulate LPs based on purchases from a single business. LPPs may also include LPPs associated with a specific credit card. As is understood, LPPs are generally created in order to promote loyalty of the user with the particular business or businesses by providing various incentives to the user through the accumulation of LPs.

When electing to participate in an LPP, a user will obtain membership with an LPP. Typically, in establishing membership with an LPP, the user opens an account with the LPP, is assigned a loyalty points account number and thereafter the account is utilized to track the accumulation and debiting of LPs from the account. As the user over time makes various purchases with either a single associated business or multiple-associated businesses, LPs are accumulated within the user's account. Typically, at the time a purchase is made, the user will present in person a loyalty card that links a transaction to the LPP such that LPs are credited to the users LPs account. Alternatively, for example in the case of a credit card, the credit card account is linked to the LPP such that LPs are automatically credited to the LPP on a regular basis (e.g. monthly).

In each case, the user will typically have an LPs balance that can be used for the purchase of goods or services. The types of goods or services that can be purchased using LPs are typically limited to specific goods or services provided by the LPP. For example, in the case of Air Miles™ or Aeroplan™, LPs can be used for obtaining airline travel (often with specific airlines) and/or for other specific services or specific merchandise offered by the LPP. In each case, an offered product or service can be obtained by spending a fixed number of LPs to obtain that product or service. In the event that a user does not have a required number of LPs to obtain a desired product or service, with some programs, additional points may be purchased with money or traded with LPs from other programs to obtain the required number of LPs to make a desired purchase.

In addition, LPPs may provide various offers from time to time for a user to accumulate LPs at a faster rate. For example, an LPP may offer that bonus points may be acquired for purchases made with specific vendors within a specific time frame.

In operating an LPP, the LPs represent a future liability to the LPP in that a future service or product may be claimed by the user which must be provided by the LPP. As the LP is not money and the correlation between the LP and money can be varied, the actual liability to the LPP is somewhat uncertain. Moreover, there may be a wide number of other variables that may affect the true value of the liability. Such variables may include redemption rates, LP expiry dates, user demand for specific products, costs billed by third party suppliers and other factors.

Importantly, as LPs are accumulated within an LP account, unlike a bank account, no interest is accumulated within the LP account. In fact, in many cases, the opposite is the case, as LPs may have a time-limit or expiry date associated with them wherein after an LP has been within an account for a specific period of time, if that LP has not been utilized, it will expire with no value. For example, Aeroplan™ assigns an expiry date with each LP credited to a user's account, currently seven years from the date it was credited to the account. If that LP is not used within seven years, it will expire with no value. Purchases or use of LPs will automatically utilize the oldest points within a user's account such that a user does not have to directly decide which points to use; however, if a user's account is dormant for a period of time, there is a risk that the points will expire. As noted above, this is primarily to ensure that the liabilities of the LPP do not continuously grow given the predictable percentage of people who will not use their points.

In accordance with embodiments of the invention, LPPs are linked to a gaming system that allows a user to use his or her LPs for gaming. The system allows a user to transfer LPs to the gaming system wherein the user can game utilizing the LPs as gaming credits. Upon winning, the user would accumulate additional LPs that could be transferred back to his or her LPP account and if a player loses while gaming with the LPs, the lost LPs would be credited to the gaming system. While a user's LPs are within a gaming system account, the user will accumulate additional credits in the form of interest.

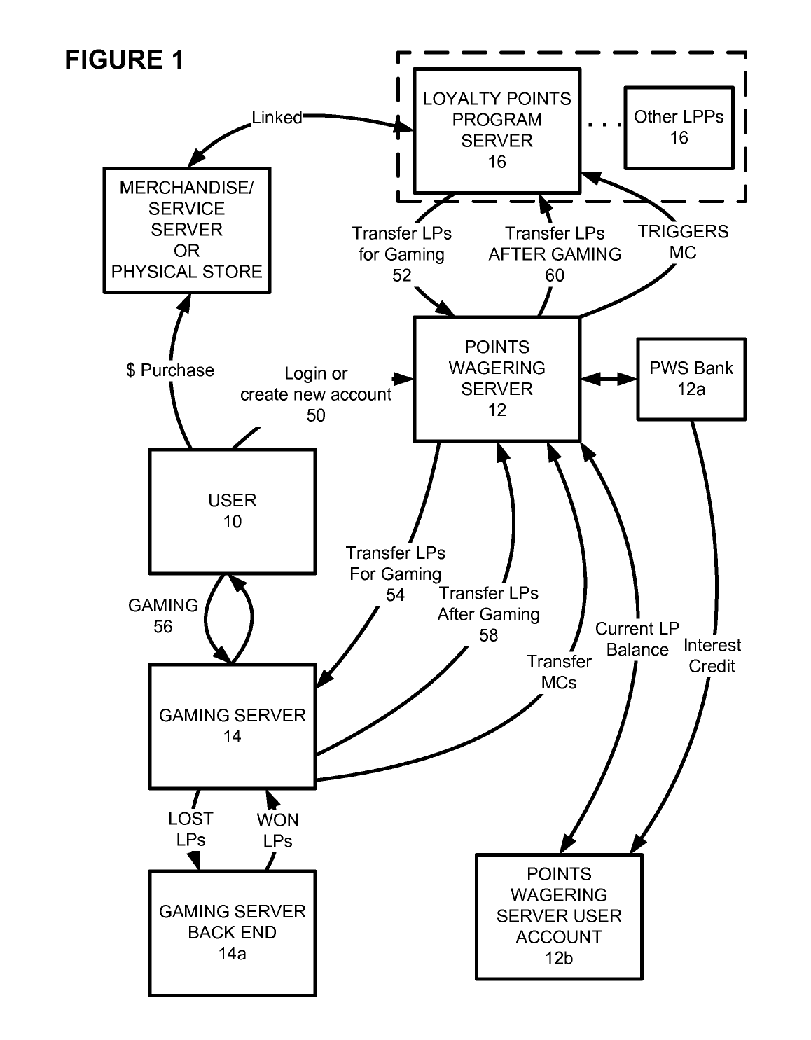

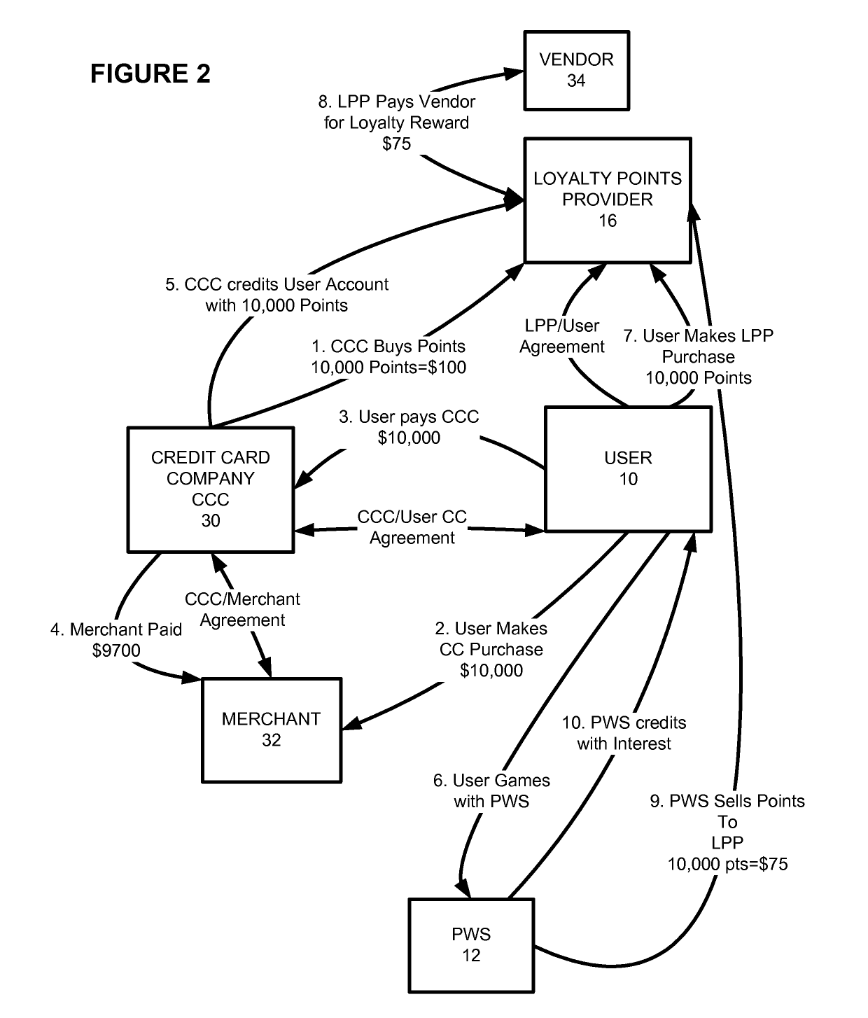

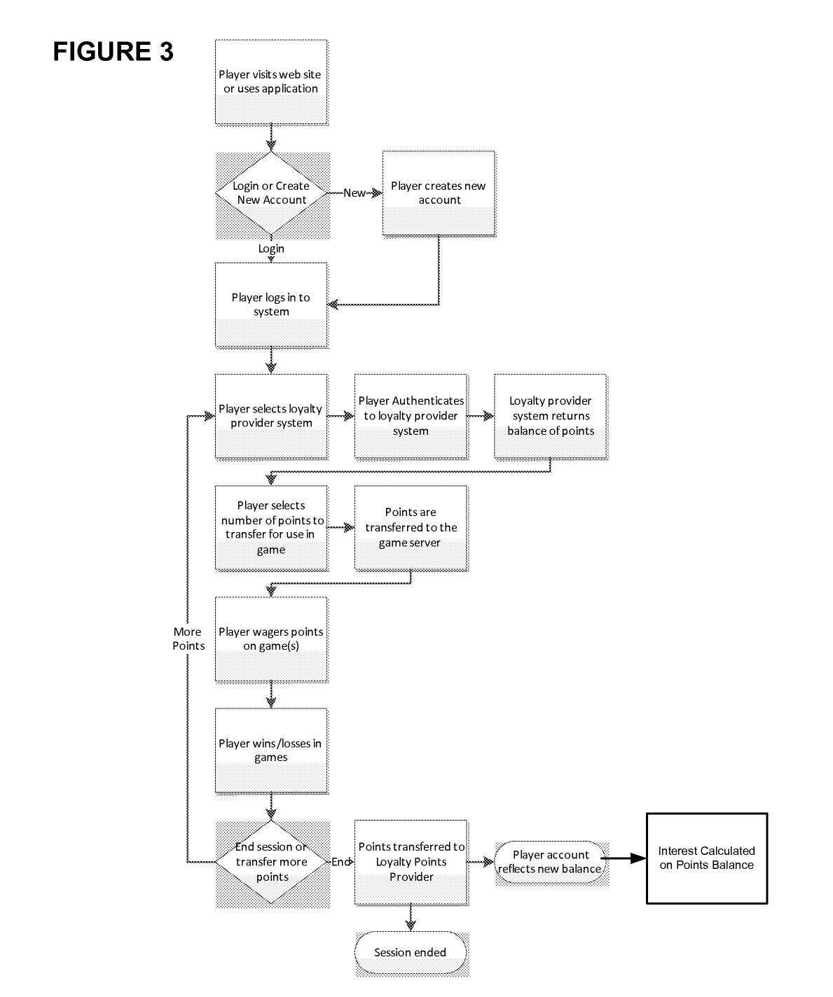

The general operation of the system is shown in FIGS. 1 and 2. FIGS. 3-5 are flowcharts that show the general steps within the system in different embodiments. Each flowchart describes the functionality that may be implemented within a Points Wagering System (PWS) with various computer hardware systems and software. It is understood that the different physical hardware and software systems may be designed by one skilled in the art to provide the functionality of the system and that the following descriptions are not intended to be limiting in terms of the physical design of the system.

As shown in FIG. 1, a user 10 can connect to and interface with a Points Wagering System (PWS) 12 (typically embodied as a server supporting a website). The PWS in conjunction with a Gaming Server (GS) 14 and Loyalty Points Program Server (LPPS) 16 supports the general functionality of the system. Once connected to the PWS 12, the user can login to an existing account or create a new account 50. Once the user is registered with an account 12b, appropriate functionality is provided to allow the user to link to an authorized LPPS to access and transfer LPs 52 that are within the user's LPP account on the LPPS. For example, a typical LPPS might be the Air Miles™ server where a user has accumulated 10,000 Air Miles™ points within his or her Air Miles™ account.

The PWS allows the user to transfer LPs for the purposes of gaming. Once authorized, the user may transfer 54 a specific number of LPs through the PWS that then become usable for gaming within a gaming account on the GS (also referred to herein as a PWS account). The GS may be integral with the PWS or be separate as understood by those skilled in the art but for the purposes of description herein is described as a separate server. In either event, a gaming account on the GS is credited with the authorized number of LPs that the user can then access for gaming. For example, a user may choose to transfer 2000 points from the LPPS to the PWS and GS, leaving a balance of 8000 points on the LPPS. As explained in greater detail below, in one embodiment, interest is calculated and credited to a user's PWS account based on pre-determined interest formulae.

The user would then proceed to game 56 on the GS (typically using his or her own remote computer as an interface with the GS) in the normal way by wagering a specific number of LPs in a wagering game such as but not limited to slot-type, blackjack, poker, keno, as well as many other electronic type wagering games. During gaming, the user's position with respect to his or her LPs would be displayed back to the user. For example, a user may proceed with various games and initially lose 1000 points displaying a current credit of 1000 LPs (relative to the initial balance of 2000 points). Further gaming may result in a number of successive wins in which the resulting balance of LPs grows to 3000.

At this juncture, the user may wish to end his or her gaming session. With a close-out balance of 3000 points, the user would be able to transfer 58 all or part of the LP balance back to the PWS and to the LPPS 60 if they so choose, thus resulting in a current balance in the LPP account of 11,000 LPs. Similarly, in the event that the user finished gaming after being down 1000 LPs, the current balance in the LPP account after transfer from the GS would be 9,000 LPs. The user may also elect to keep his or her LPs on the GS or PWS if the GS/PWS is so configured. In one embodiment, to further encourage the use of the PWS, interest is credited to a user's account 12b within the PWS.

Reconciliation of the LPs won or lost during gaming would be supported by a Gaming Server Back End (GSBE) 14a which supports the management of the different LPs that may be used within the GS. The GSBE may integral with and/or be at the same location as the GS or may be separate to and networked to the GS as known to those skilled in the art.

The GS 14 would support games having typical electronic game payouts wherein the house (i.e. the system as supported by the GS and GSBE). As a result, over time, the house would be expected to accumulate a “profit” in the form of LPs from the house advantage. For example, with a typical payout of 94%, the user wagering 2000 points would be expected to lose 120 points during gaming allowing the house to accumulate 120 LPs.

Agreements between the LPPs and the PWS would allow for the LPs to be returned to the LPPs at an appropriate money/LP conversion rate, thus allowing the PW system to accumulate a money profit. Initial seeding of a PWS bank 12a may be through the purchase of LPs. The PWS bank 12a will reconcile LPs won and lost during gaming with the GSBE 14a.

In addition, the PWS can utilize the profit as a means of providing interest credits to a user's PWS account. That is, in our example of the user having a 3000 LP balance within his or her PWS account, the user may be credited at a rate of 7% per annum compounded daily and based on a daily minimum balance. Thus, in the case of 3000 LPs being the minimum amount in the account during a day (e.g. the day after the above described gaming), and no further activity occurs in the user's account, at the end of one year, the user would have 3217.50 LPs in their account. Obviously, the specific interest rate and conditions can be highly variable based on any number of factors. The PWS may also implement LP expiry provisions for the same reasons that an LPP does to prevent dormant accounts. In the alternative, the PWS may also implement a requirement that the LPs within a dormant account are transferred back to the LPP account after a particular period of time in order to prevent points expiry. Further still, the PWS may implement different interest rates based on user activity. For example, accounts that are “active”, the interest rate may be higher, accounts that are “semi-active” may have a lower rate, and accounts that are “dormant” may have a zero rate. An active account may be one where the user has actively participated in gaming with LPs in the past month, a semi-active account may be one where there has only been activity in the past 1-12 months, and a dormant account may be one where there has no activity in the past 12 months. As such, by promoting the payment of interest on a points balance, this offering will both encourage the general use of the system as well as the gaming component of the system.

A representative financial arrangement between the parties participating in the PWS is shown in FIG. 2. It should be noted that the arrangements illustrated are representative only and that the relationships between the parties could vary between each party as described and shown. In addition, the dollar and points amounts are shown as nominal amounts merely to illustrate the advantages to each party of the system. In our representative example, there are agreements in place between a) the user and credit card company (CCC) 30, b) the CCC and the LPP 16, c) the user 10 and the LPP and d) the PWS 12 and the LPP. The typical transactions may be as follows:
1. A credit card company 30 buys 10,000 LPs from an LPP for $100 (1 point=$0.01);
2. The credit card member (user) 10 makes $10,000 worth of purchases with a third party merchant 32 using the credit card (CC).
3. The user pays the CCC $10,000 for the purchase.
4. Based on the $10,000 worth of purchases, the credit card company pays the merchant $9700 for the $10,000 purchase based on a typical 3% merchant fee.
5. The CCC credits 10,000 points to the member's LPP account. As such, the transaction cost to the CCC for crediting the user's LPP account is $100, however, given the merchant fee, the CCC nets $200 from the transactions. The LPP now has a potential $100 (value approximate) liability to the member.
6. The user may choose to game with the PWS 12 in an attempt to increase the total number of LPs.
7. Regardless of the user's success of gaming with the PWS, at some time the user chooses to redeem 10,000 points for an air travel ticket with a vendor 34 (e.g. an airline). The user, using the LPP website, purchases an air ticket having a “retail” value of $100 using their 10,000 points. The 10,000 points are deducted from the user's account.
8. To meet the obligation to the user, the LPP purchases from the airline an air ticket at a “wholesale” price. For example, if the retail value of the ticket is $100, the wholesale price might be $75, realizing a $25 profit to the LPP.
9. The PWS will accumulate LPs as a result of user gaming. Assuming that the PWS has accumulated 10,000 points based on user gaming, the PWS may sell 10,000 points to the LPP for $75 (i.e. for $0.0075 per point; a “wholesale value”). Thus, the PWS has realized a profit of $75.
10. The PWS may also credit the user's account with interest in accordance with pre-determined rules.

Thus, with the introduction of a PWS, the PWS can return LPs that have been accumulated with the PWS to the LPP typically at “wholesale” prices or lower such that profit is realized is realized by both the PWS and LPP. That is, in our example, the LPP has had 10,000 points returned to them for only $75 which they can then sell again to the CCC for $100 (i.e. the “retail value”), realizing a $25 profit.

FIG. 3 is a flow chart describing a typical interaction of a user/player with the system.

As shown, the user visits a web site supporting the system functionality. The player logs in or creates a new account and logs in. After logging in, the user may select a specific LPP from a list of LPPs linked or participating in the system. After the user authenticates with a selected LPP, the LPP displays and/or enables access to a user's LPs within the LPP account. The user selects a number of points to be transferred to the PWS which are transferred to a GS for access during gaming. The user participates in gaming using their LPs as game credits and will win or lose LPs during gaming. During a gaming session, the user can either transfer additional points or end gaming as they choose in which case any remaining balance of LPs are returned to the LPP (or held in a GS account where interest may be credited). If transferred, the LPP account or GS account will reflect the new balance of LPs.

### Multiplier Credits and Bonus Points

In alternate embodiments, the user would not win additional LPs per se, but rather, would accumulate other “rewards” in the event that the user's gaming is successful. For example, the user may win “multiplier credits” (MCs) from gaming or bonus points. A multiplier credit is generally defined as an award that would be realized upon the completion of a future transaction with the LPP. For example, during gaming the user may win 1000 additional LPs. In this example, rather than directly crediting their LPP account with an additional 1000 LPs, a future purchase of an offered product or service from the LPP or merchant would provide the user with a multiplied number of credits on purchases made within a specific time period or up to a certain amount of loyalty points. For example, if the player wins 1000 LPs in their gaming session, this will trigger the accumulation of 10× their loyalty points on all purchases they make with the LPP or merchant within the next week. Thus, after gaming and the successful triggering of the MC threshold, if the user goes to the LPP store (or other merchant) and buys $100 of merchandise, instead of receiving a regular number of LPs, the user would receive a multiplied number of LPs. As is typical, LPs are often rewarded at $1=1 point ratio, thus, in this scenario; the user would receive 1000 LPs on his or her $100 purchase instead of the usual 100 LPs.

In another embodiment, a user may simply be provided with bonus points if a purchase is made. In the case of a merchant, the merchant would typically purchase additional points from the LPP at a wholesale amount. For example, the additional 900 points having a wholesale value of $0.0075 each would cost the merchant an additional $6.75 ($6.75 being in addition to the cost of the regular 100 points costing $0.75) that is paid to the LPP. In a typical scenario, the merchandise purchased from the merchant has a wholesale value of $40-50 relative to the selling retail price of $100. Thus, the merchant will pay the LPP a total of $7.50 for the points purchase, thus still realizing a profit of $42.50-$52.50 on the purchase.

Thus, an MC or bonus points system provides incentive for a user to make additional purchases with the LPP within a period of time. The MC or bonus points system can also be used as an effective marketing tool for a merchant and thereby promote sales of merchandise.

In the event that the user does not make the purchase within a specified time period, the MCs or bonus points criteria may expire.

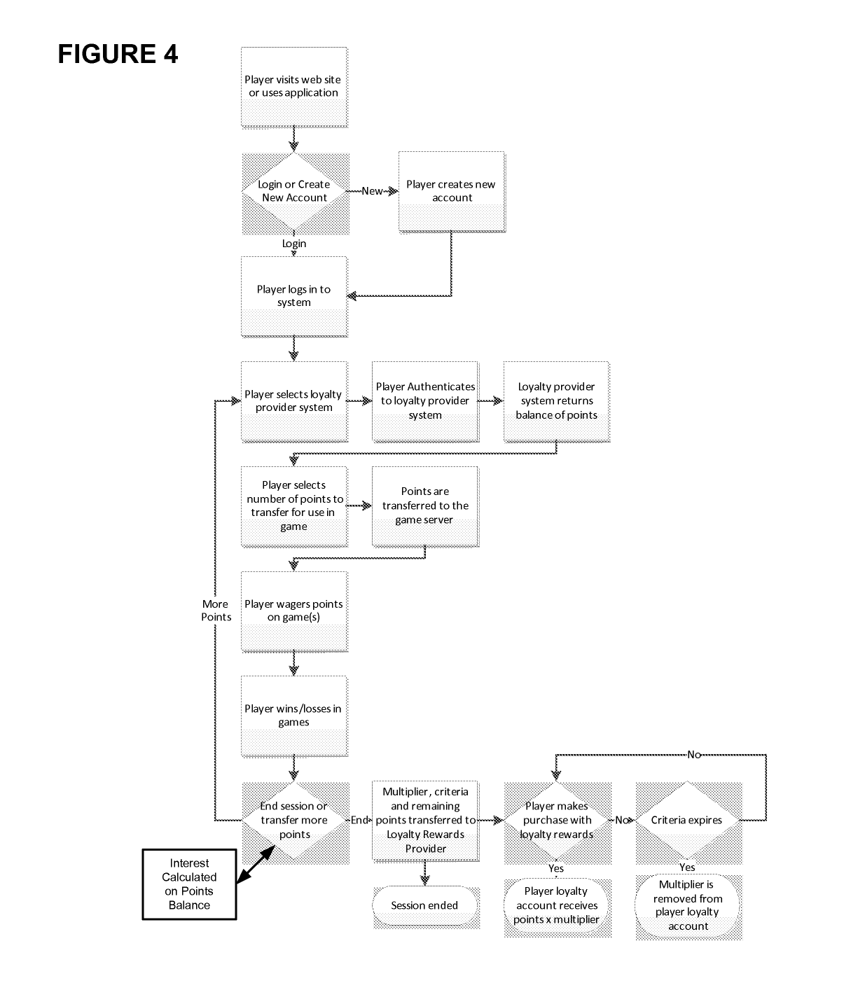

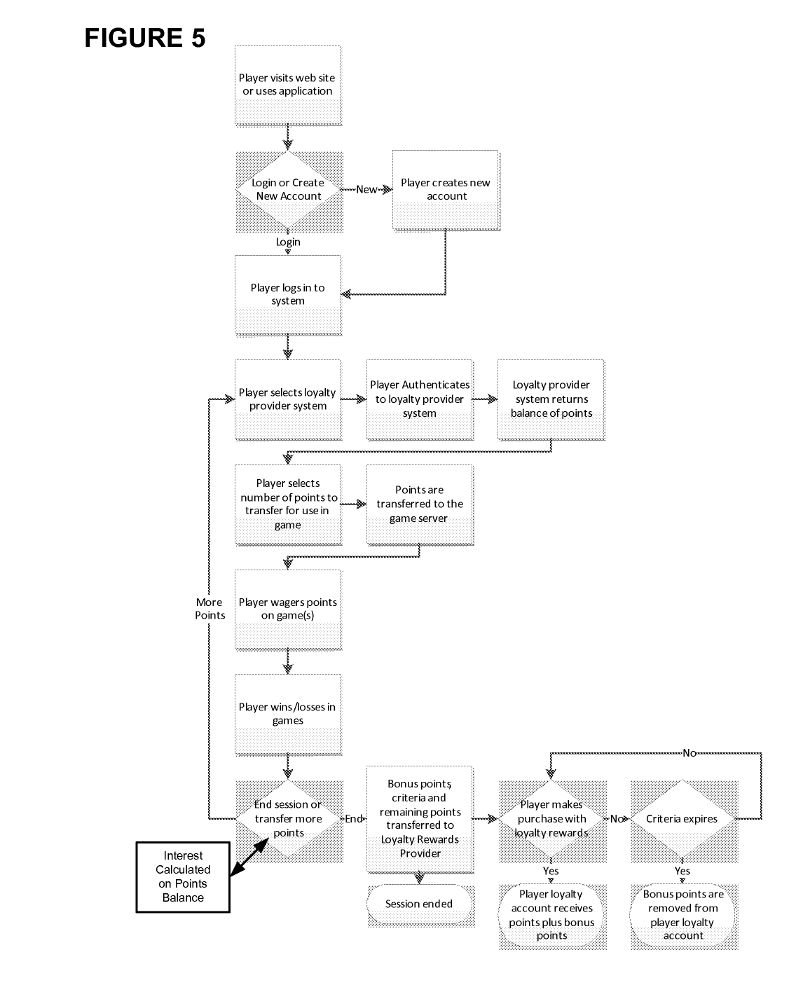

FIGS. 4 and 5 are flow charts describing potential interactions of a user/player with the system in which MCs or bonus points are utilized as generally described above. As shown in these Figures, as in FIG. 3, the user may win or lose points during a gaming session. Depending on the particulars of a particular bonus points offering, a user may be awarded multiplier credits as in FIG. 4 as a result of the gaming session. After completion of a gaming session, a multiplier credit as well as any points within the user gaming account may be transferred back to the LPP. If, within a specified time period, the user uses his or her points to make a purchase, the transaction may trigger the multiplier credit such that additional points are transferred to the user's LP account. If a purchase is not made within the specified period, the bonus points may expire and no adjustment is made to the user's points balance.

In another scenario as shown in FIG. 5, after completion of a gaming session, bonus points derived from the gaming session as well as any other points within the user gaming account may be transferred back to the LPP where the user may use his or her points to make a purchase. In one representative scenario, if a player makes a purchase within a pre-determined time period, the transaction may trigger a further points and/or bonus points award which would add points to the user's LP account. If a purchase is not made, the bonus points from the gaming session may expire and the user's points balance adjusted.

It is understood that these scenarios are representative and that various criteria may be utilized to effect different bonus points/multiplier credit awards.

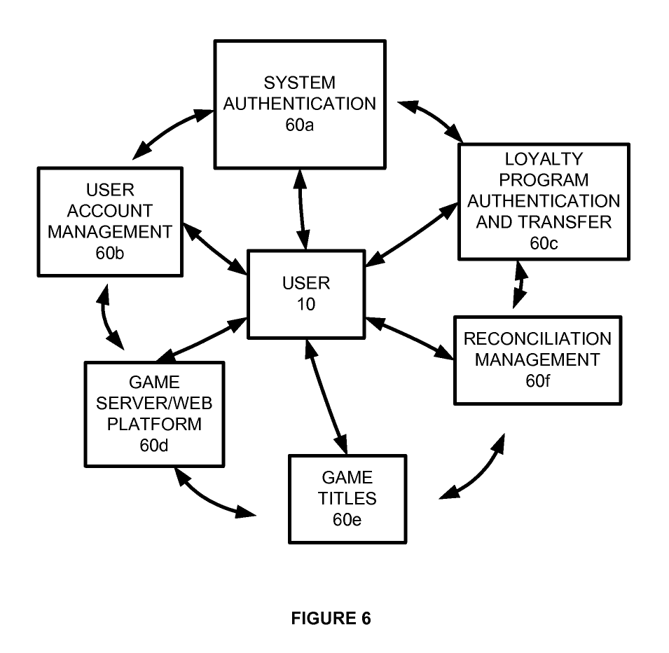

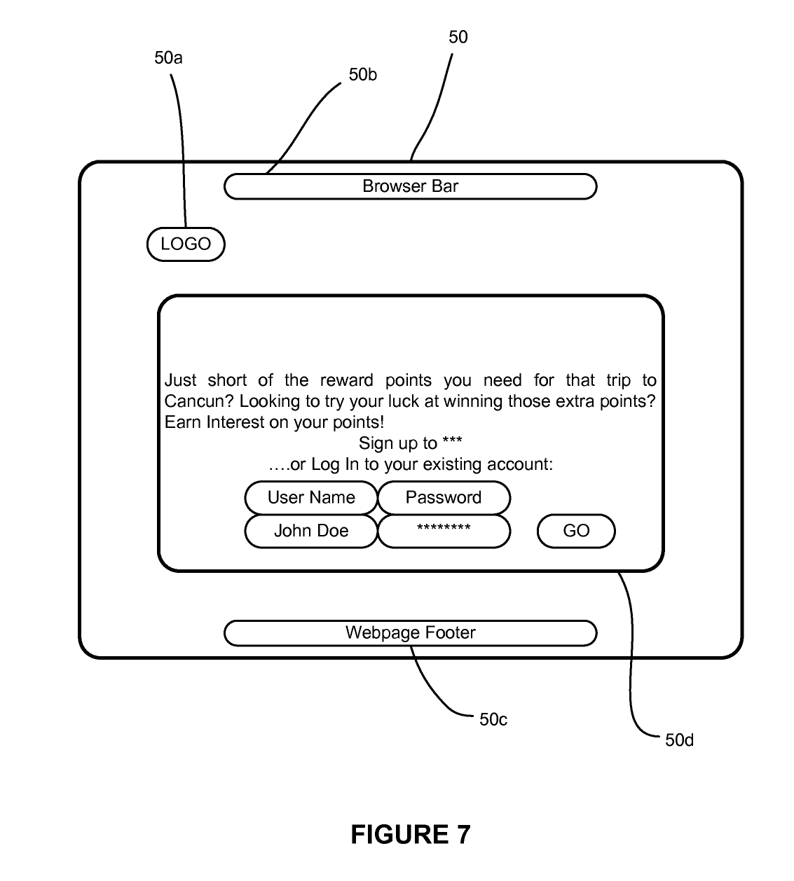

Further details of PWS are described with reference to FIGS. 6-14 that show user interaction with various software modules and that illustrate a representative front-end implementation of the system for the user. That is, FIGS. 7-14 illustrate potential user-interfaces to the system with a website/webpage interface.

As shown in FIG. 7, a user accesses the PWS website from their Internet browser. The website may include typical website features including identifying logos 50a, a browser bar 50b and webpage footer 50c. Upon accessing a login page within page specific instructions/information 50d, the user may select to access an existing account or create a new account. The benefits of using the PWS may be displayed including the ability to win points as well as earn interest on points.

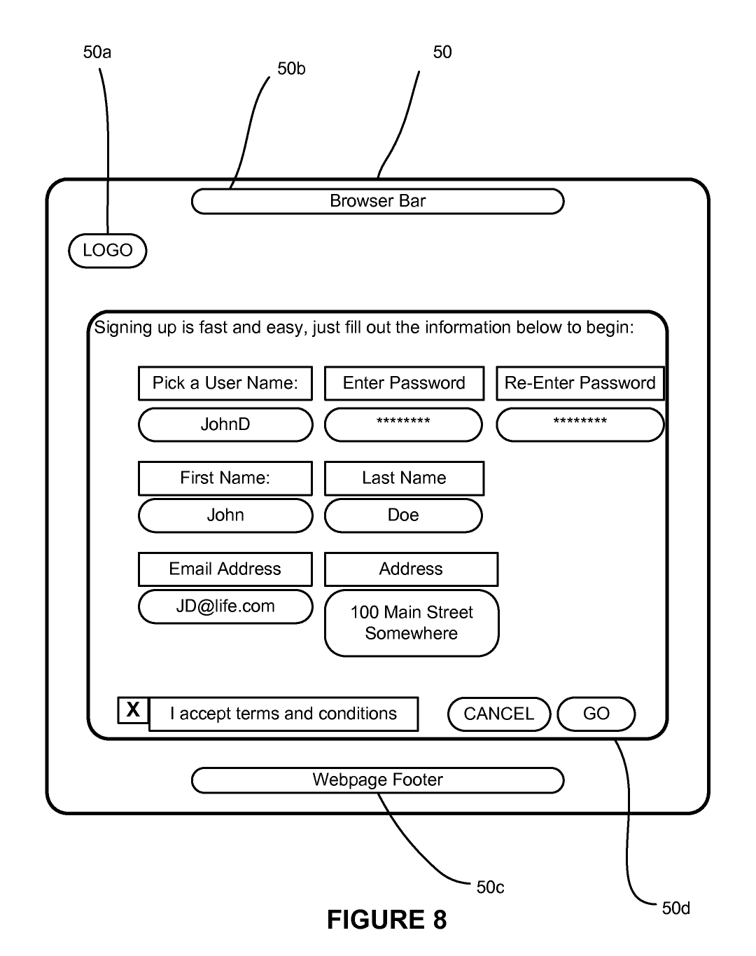

As shown in FIG. 8, typical account creation criteria may be displayed including appropriate prompts to enter a user ID and password and other identifying criteria. Creating an account uses a User Account Management module.

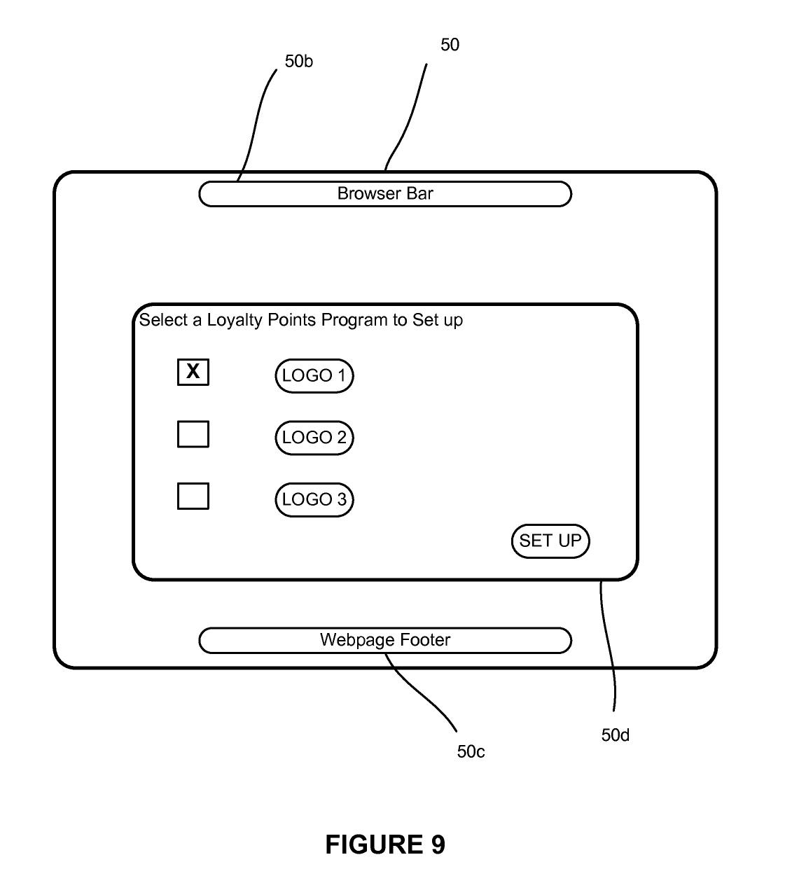

As shown in FIG. 9, after creating an account and logging in, the user can connect his or her specific LPP accounts to his or her PWS account. For example, in a representative example, three LPPs may be participating in the PWS system, shown as Logos 1-3. The user may have points with one LPP and thus select that LPP as to link to the PWS. As is understood, not all LPPs will be linked to the PWS. However, as the system is implemented, it is understood that the number of LLPs that can be connected to the PWS will grow. After selecting a particular LPP, the user can initiate the linking process.

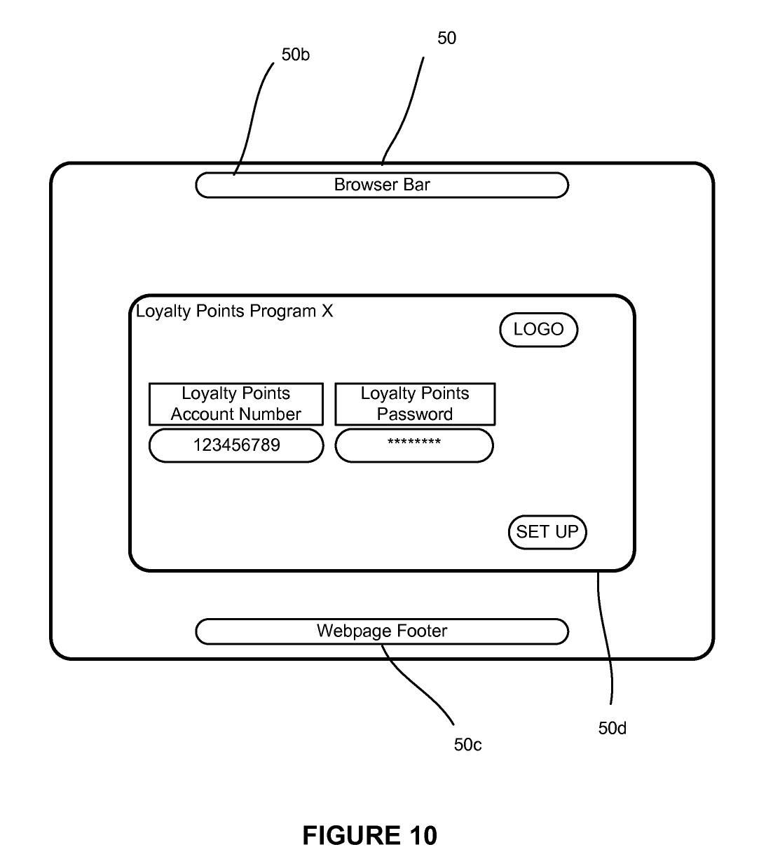

As shown in FIG. 10, after a specific LPP is selected, the user may be prompted to enter specific login information for that LPP. Operative connection between the PWS and LPPs will utilize a Loyalty Program Authentication module that enables the appropriate communication between different servers.

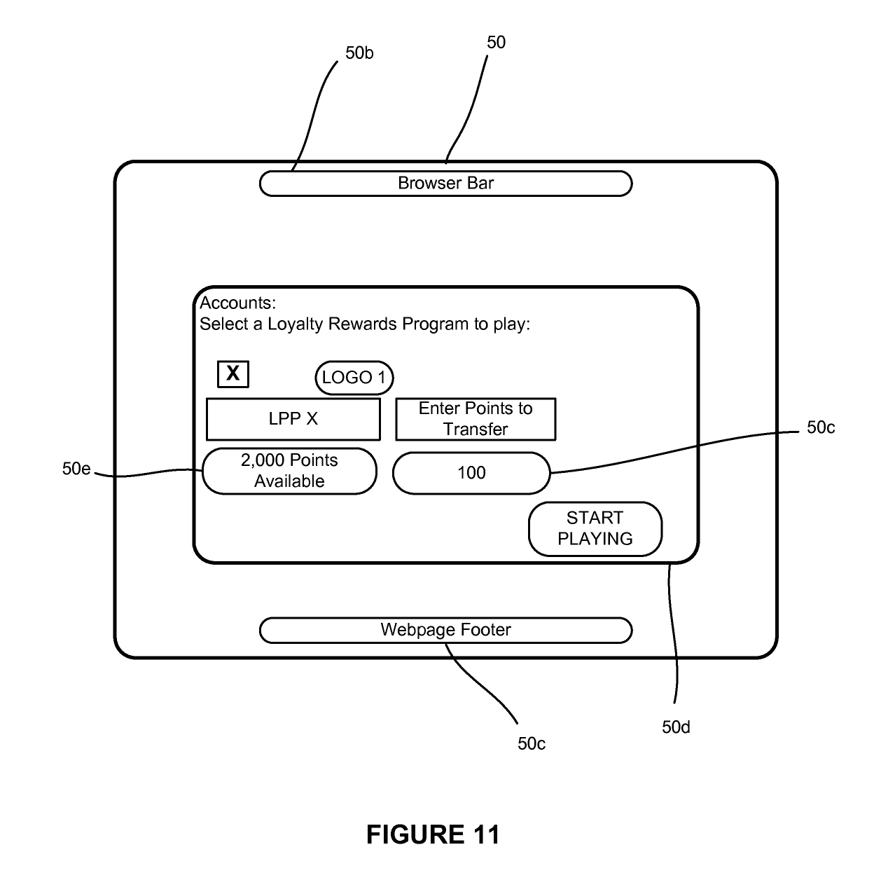

As shown in FIG. 11, once an LPP account is added to the PWS, the current points balance 50e that is available for transfer is displayed. The transfer of LPs to the PWS utilizes a Transfer module. The user may enter the number of points 50f he or she wishes to transfer to the PWS.

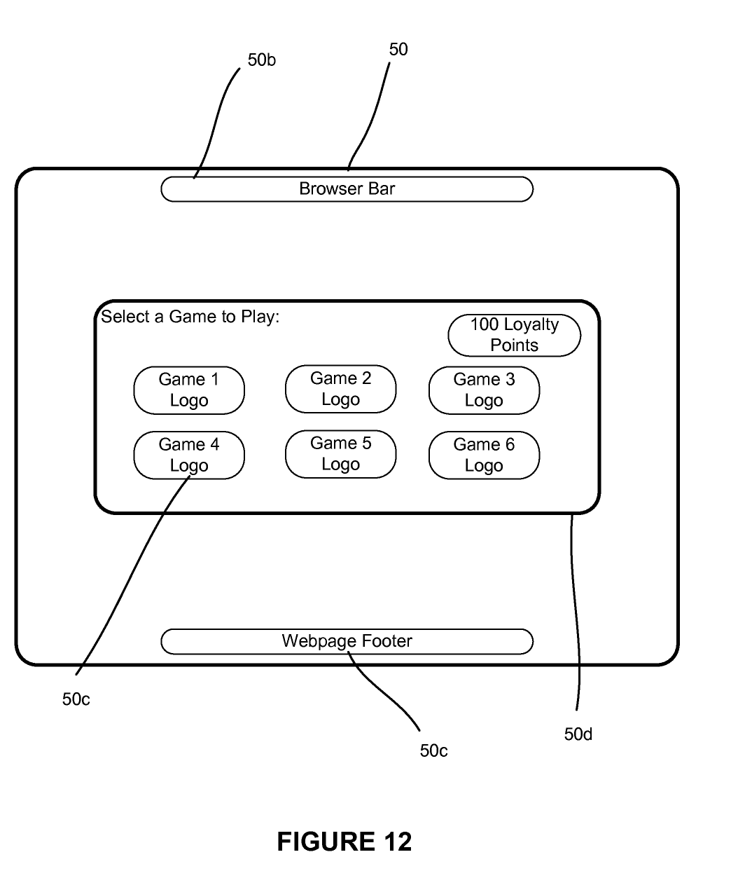

As shown in FIG. 12, once a transfer has been made, the user may be presented with a screen showing logos/descriptors of various games 50g that they may play as well the number of points available to play with. Accessing games utilizes the Game Server and Game Title modules.

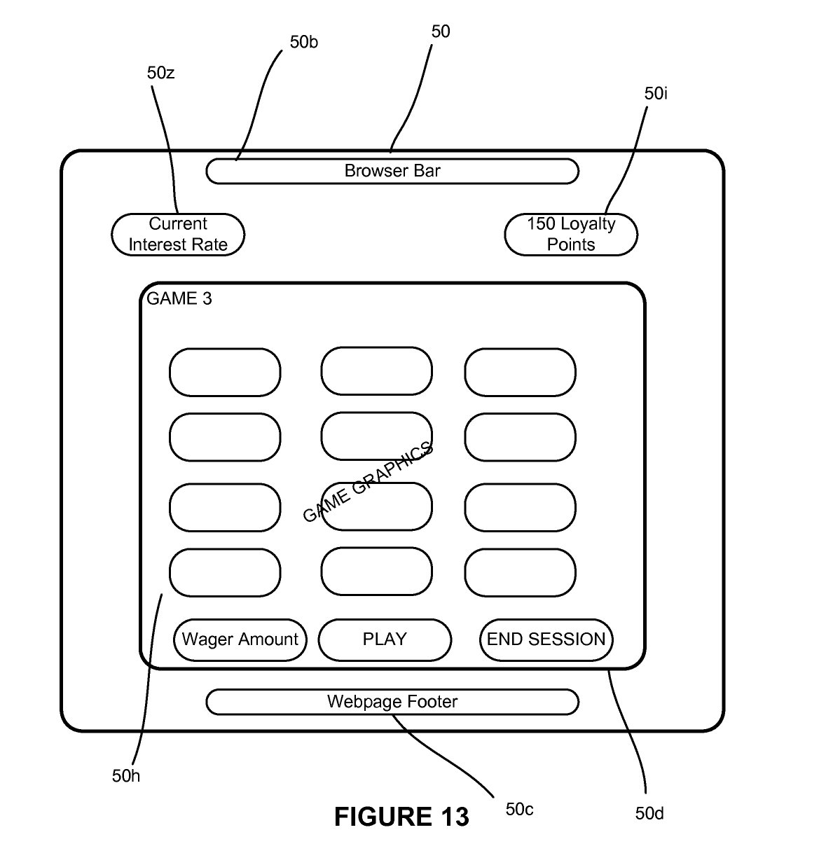

As shown in FIG. 13, once a game has been selected, the user may play a game 50h utilizing his or her LPs. The current total of their LPs may be displayed 50i. In addition, the current interest rate that is applicable based on the user's play rate may be displayed 50z.

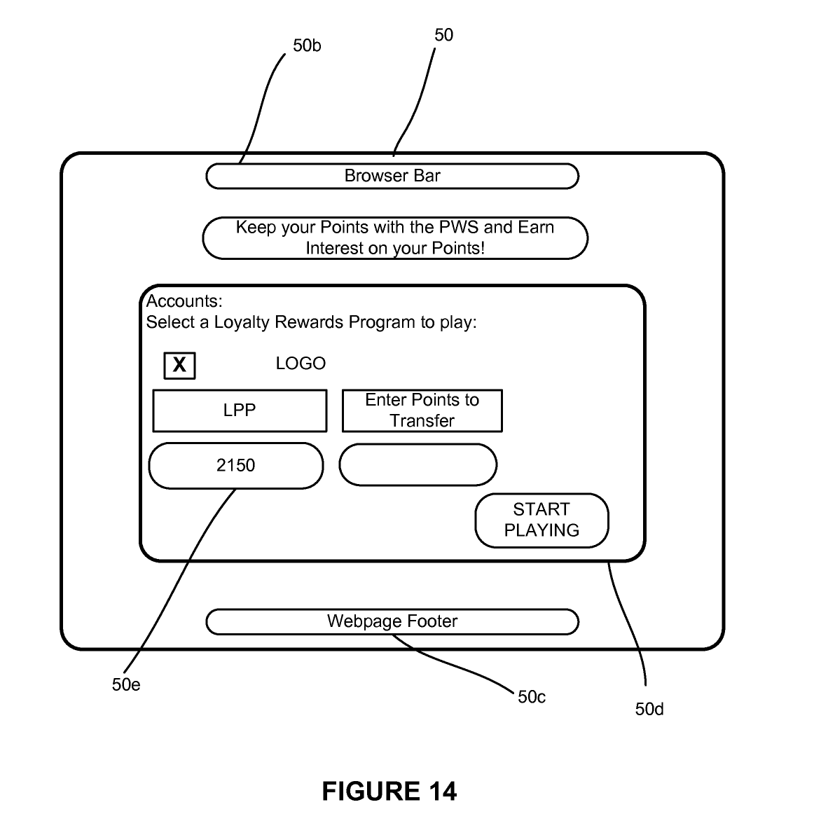

As shown in FIG. 14, after ending a gaming session, winnings and losses are added or removed from the user account during game play and are displayed to the user as a new total balance 50e in the user's LPP account. Upon the completion of gaming, the user may choose to transfer the remaining and/or accumulated points back to the LPP account. Alternatively, the LPs may be left for future play in the PWS where interest may be credited to the user's account.

### Software Modules

As such, and as described in greater detail below, the primary functionality of the system is provided through a number of software modules that control and support the system. Importantly, the software modules collectively and individually provide and/or support graphical user interfaces that provide information to the users to effect and control the entry of user inputs into the system and to effectively display information back to the user to prompt user inputs and to maintain player interest in the system. That is, collectively, the hardware and software of the PWS presents information to the user that provides a user with the incentive and/or desire to interface with the system to realize a previously unavailable objective of accumulating LPs through gaming activities while simultaneously providing entertainment to the user. Thus, the system provides an opportunity to acquire LPs and provide entertainment without wagering real money. As a result, many problems associated with gaming with real money are eliminated because real money is not involved as the user only has access to a limited number of LPs. In other words, the risk of realizing gambling losses beyond available LP credits is not possible.

If required or desired, in one embodiment, the PWS will not permit the user to use LPs that are be purchased through the LPP. That is, as some LPPs allow a user to purchase LPs to reach a points redemption amount, in one embodiment purchased points will not be usable with the PWS system. In this case, in the event that a user has points that have been awarded through regular purchases as well as points purchased for money, those purchased with money may be flagged as being ineligible for participation in a PWS.

As can be appreciated, the PWS can also be set up to prevent or minimize the risk of an underage person from gambling with LPs as the registration process for an LPP will typically require entry of a birth date which would could be used to bar underage members from gaming.

The primary software modules of the PWS include the following whose functionality is described below and shown in FIG. 6:

1. System Authentication 60a

2. User Account Management 60b

3. Loyalty Program Authentication and Transfer 60c

4. Game Server/Web Platform 60d

5. Game Titles 60e

6. Reconciliation Management 60f

It is understood that these modules are representative only of the general and overall functionality of the system and that the overall functionality of the system may be implemented in a variety of ways that realize the functional and operational goals of the system as understood by those skilled in the art.

### System Authentication

The System Authentication module provides and supports functionality that allows secure authentication to the system.

### User Account Management

The User Account Management component provides functionality that allows a user to create and manage their account. This includes:

1. Creation of a User Account

2. Modification to a User Account

3. Deletion of a User Account

4. User Account balance(s)

5. User History and Statistics

### Loyalty Program Authentication and Transfer

This module provides and supports functionality to allow a user to authenticate to an LPP and transfer a user specified number of points from his or her Loyalty Provider balance to their User account balance. This module also allows the transfer of points back to the user's LPP balance as well as retrieve the points balance on the Loyalty Provider account.

### Game Server/Web Platform

The Game Server/Web Platform components provide a common platform to host the game titles and provide access to the titles over the Internet. This component includes sub-components such as:

1. Game Server website

2. Common framework for Game Titles:
a. Random Number Generator
b. Shared assets (Graphics, Sounds, Media)
c. Shared Workflows

3. Network Communication

4. Process Management

5. Database and Database Functionality

6. Web Services

7. Transactional Services

### Game Titles

The Game Titles consist of the available games used for playing and wagering points. These games may include (but are not limited to):

Games of chance (Slots, Keno)

Games of Skill and Chance (Poker, Blackjack)

Games of Skill (Chess, Electronic Sports, FPS, MMOG, RPG)

Tournament Style Games (Poker Tournament)

Sports Betting

### Reconciliation Management

The Reconciliation Management module allows for the system to collect LPs from various methods for different games. Typically, the LPs are then redeemed to the Loyalty provider at a reduced cost.

Loyalty Points may be collected from:
Losses in Games of Chance
Losses or a rake in games of Skill and Chance (Poker would have a rake, while Blackjack would consist of losses)
Entry points buy in (Games of skill and tournament games may require a set number of points to enter, with a rake applied to the total entrants points)

The collected points are then reconciled or exchanged with the Loyalty provider at agreed intervals. The adjusted value of the redeemed points represents the financial viability of the system. Reconciliation Management includes the accounting of points, redemption of points, reporting and the API/Web Services required redeeming the points.

### Variations

Variations in the system may include:
1. Regional jurisdictions may require limitations on the type of games allowed—this could be handled with location technology (IP Address location) to provide filtered lists of games and game types.
2. Regional Jurisdictions may require limitations on how points winnings are redeemed by the User. Redemption could occur with direct points transfers, future purchase multipliers, or future purchase bonus points.

### Other Embodiments/Functionality

In addition, the PWS may be used as a conduit for an LPP to sell more points to their members as the PWS provides additional opportunities to users. For example, in situations where a user may have won or lost points through gaming, the user may become more aware that his or her points have a particular value that may be used for a number of rewards. Thus, in the event that a desired award is currently unavailable based on their current account balance, it is understood that the user may choose to purchase additional points at the retail value in order to obtain the reward.

Points may also be used for other types of gaming including lottery style games and progressive jackpot type games.

In a still further embodiment, the PWS may be embedded within the interface of another service provider. For example, a service provider such as Aeroplan™ may incorporate the functionality of the PWS within its own interface to enable their members to wager with their LPs. In this case, some of the functionality as described above, may not be required to enable points wagering as no transfer of points between different service providers would be required. Such an embodiment may be enabled such that the gaming modules are integral with a particular service provider or they may be accessed through other service providers. In this case, upon accessing the LPP website, the user would be able access gaming pages directly within the LPP website using LPs from that account. In this case, the transfer of LPs between the PWS and LPP would not be required and would utilize functionally similar software modules to enable gaming as described above.

Although the present invention has been described and illustrated with respect to preferred embodiments and preferred uses thereof, it is not to be so limited since modifications and changes can be made therein which are within the full, intended scope of the invention as understood by those skilled in the art.

1. A system enabling one or more users to utilize loyalty points (LPs) of a loyalty points program (LPP) for credits within a gaming system and wherein each user has an LPP account with the LPP, the system comprising:
a points wagering system (PWS) operatively connected to a loyalty points program (LPP) server, the PWS having an interface and software enabling users to access the LPs within their LPP account and to transfer LPs to the gaming system into a gaming system account, wherein, based on a balance of LPs within the gaming system account, interest is credited to the user's gaming system account based on pre-determined interest rules.

2. The system as in claim 1 wherein the pre-determined interest rules include calculating and crediting interest based on a user's activity with the PWS within time-thresholds.

3. The system as in claim 2 wherein a higher rate of interest is credited to the user's gaming system account if the user has PWS activity within a first time threshold and a lower rate of interest is credited to the user's account if the user has no PWS activity within a second time threshold, wherein the first time threshold is shorter than the second time threshold.

4. The system as in claim 3 wherein the PWS server displays information to the user regarding a current interest rate to the user based on the user's current PWS activity.

5. A method of earning interest on loyalty points (LPs) within an account comprising the steps of:
at a loyalty point provider (LPP);
displaying information to a user offering the use of LPs as gaming credits within a gaming system and the opportunity to win additional LPs and earn interest on the LPs;
at a points wagering system (PWS);
providing LP gaming on a gaming server (GS) and crediting a user's gaming system account with additional LPs based on pre-determined interest rules.

6. The method as in claim 5 wherein the pre-determined interest rules include calculating and crediting interest based on the user's activity with the PWS within time-thresholds.

7. The method as in claim 6 further comprising the step of crediting higher interest to the user's gaming system account if the user has PWS activity within a first time threshold and lower interest to the user's account if a user has no PWS activity within a second time threshold and where the first time threshold is shorter than the second time threshold.

8. The method as in claim 7 further comprising the step of displaying information to the user regarding a current interest rate applicable to the user based on the user's current PWS activity.
